(19) United States
(12) Patent Application Publication
(10) Pub. No.: US 2011/0290525 A1
(43) Pub. Date: Dec. 1, 2011

(54) FLUORINE-CONTAINING ELASTOMER COVERED ELECTRIC WIRE, AND METHOD FOR MAKING SAME

(75) Inventors: Hitoshi KIMURA, Hitachi (JP); Takuya Suzuki, Hitachi (JP)

(73) Assignee: HITACHI CABLE, LTD., Tokyo (JP)

(21) Appl. No.: 13/149,442

(22) Filed: May 31, 2011

(30) Foreign Application Priority Data
May 31, 2010 (JP) 2010-123945

(51) Int. Cl. H01B 3/30; B05D 5/12; C08J 7/18

(52) U.S. Cl. 174/110 SR; 427/501; 427/513; 427/117

(57) ABSTRACT

A fluorine-containing elastomer covered electric wire includes a conductor, and a covering layer on a periphery of the conductor. The covering layer includes a composition including 100 parts by weight of a tetrafluoroethylene-propylene system copolymer and 0.1 to 10 parts by weight of a fatty acid amide.

The present application is based on Japanese patent application No.2010-123945 filed on May 31, 2010, the entire contents of which are incorporated herein by reference.

### BACKGROUND OF THE INVENTION

1. Field of the Invention

This invention relates to a fluorine-containing elastomer covered electric wire, and a method for making the fluorine-containing elastomer covered electric wire. In particular, this invention relates to a fluorine-containing elastomer covered electric wire with an easy stripping property (or peeling property) in processing a covering at the terminal of the wire, a method for making the fluorine-containing elastomer covered electric wire.

2. Description of the Related Art

JP-A-2009-140683 discloses a fluorine-containing elastomer covered electric wire that a composition comprised of 100 parts by weight of tetrafluoroethylene-propylene system copolymer and 0.5 to 20 parts by weight of antimony trioxide is used to form a covering layer on the periphery of a conductor.

The fluorine-containing elastomer covered electric wire disclosed in JP-A-2009-140683 may improve the flame retardance since the antimony trioxide is added at a predetermined amount to the tetrafluoroethylene-propylene system copolymer.

### SUMMARY OF THE INVENTION

Thus, the composition as disclosed in JP-A-2009-140683 may improve the flame retardance of the fluorine-containing elastomer covered electric wire. However, when the composition is used to form a covering layer on a non-plated conductor or a silver-plated conductor, the covering layer in processing the terminal of the fluorine-containing elastomer covered electric wire may be not easy to strip or peel since the covering layer has a strong adherence to the conductor. In this case, when using a conductor with small-diameter wires stranded, the conductor may be damaged in stripping the covering layer. Thus, the fluorine-containing elastomer covered electric wire disclosed in JP-A-2009-140683 needs to be improved in the wire stripping property.

Accordingly, it is an object of the invention to provide a fluorine-containing elastomer covered electric wire that the covering layer thereof can be enhanced in the stripping property from the conductor to improve the terminal processing property as well as a method for making the fluorine-containing elastomer covered electric wire.

(1) According to one embodiment of the invention, a fluorine-containing elastomer covered electric wire comprises:

a conductor; and

a covering layer on a periphery of the conductor,

wherein the covering layer comprises a composition comprising 100 parts by weight of a tetrafluoroethylene-propylene system copolymer and 0.1 to 10 parts by weight of a fatty acid amide.

In the above embodiment (1) of the invention, the following modifications and changes can be made.

(i) The covering layer comprises a cross-linking structure.

(ii) The tetrafluoroethylene-propylene system copolymer comprises a mole ratio of tetrafluoroethylene to propylene in a range of 90/10 to 45/55.

(2) According to another embodiment of the invention, a method for making a fluorine-containing elastomer covered electric wire comprises:

forming on a periphery of a conductor a covering layer comprising a composition comprising 100 parts by weight of a tetrafluoroethylene-propylene system copolymer and 0.1 to 10 parts by weight of a fatty acid amide,

cross-linking the composition so as to form a cross-linking structure in the covering layer.

In the above embodiment (2) of the invention, the following modifications and changes can be made.

(iii) The cross-linking of the composition comprises a cross-linking by a cross-linking agent previously included in the composition, or a cross-linking by irradiating the composition with electron beam or ultraviolet rays.

### Points of the Invention

According to one embodiment of the invention, a fluorine-containing elastomer covered electric wire is constructed such that a covering layer formed on a conductor is enhanced in stripping property and formed by extruding on the periphery of the conductor the compound formed by kneading a predetermined amount of tetrafluoroethylene-propylene system copolymer and a predetermined amount of fatty acid amide. Therefore, the fluorine-containing elastomer covered electric wire with the excellent terminal processing property can be provided. In other words, the fluorine-containing elastomer covered electric wire can be excellent in wire stripping property, so that the conductor can be prevented from being damaged in stripping the covering layer from the conductor.

### BRIEF DESCRIPTION OF THE DRAWINGS

The preferred embodiments according to the invention will be explained below referring to the drawings, wherein:

FIG. 1 is a cross sectional view showing a fluorine-containing elastomer covered electric wire in a preferred embodiment of the invention; and

FIG. 2 is a process diagram showing a method for making the fluorine-containing elastomer covered electric wire in the embodiment of the invention.

### DETAILED DESCRIPTION OF THE PREFERRED EMBODIMENTS

### Findings of the Inventors

The inventors have found that a composition comprised of 100 parts by weight of tetrafluoroethylene-propylene system copolymer and not less than 0.1 parts and not more than 10 parts by weight of fatty acid amides may be used to form a covering layer 20 on the periphery of a conductor 10 so as to control the core adherence of the covering layer 20 to the conductor 10 without lowering the mechanical properties and the heat resistance of the covering layer 20 to significantly enhance the terminal processing property. In addition, the inventors have found that not less than 0.1 parts by weight of fatty acid amides can be preferably added to have the effect of reducing the core adherence, and not more than 10 parts by weight of fatty acid amides can be preferably added to have the effect of preventing the reduction of the heat resistance. The following embodiments of the invention are based on the above findings of the inventors.

### Summary of the Embodiments

The embodiment of the invention is to provide a fluorine-containing elastomer covered electric wire comprising a conductor and a covering layer formed on the periphery of the conductor, where the covering layer comprises a composition comprised of 100 parts by weight of tetrafluoroethylene-propylene system copolymer and not less than 0.1 parts and not more than 10 parts by weight of fatty acid amides.

### Embodiment

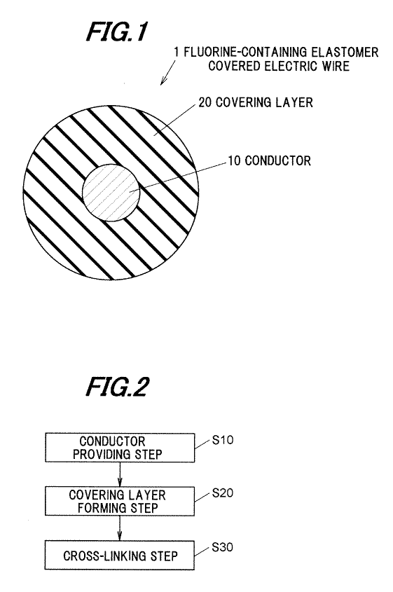

FIG. 1 is a cross sectional view showing a fluorine-containing elastomer covered electric wire in the embodiment of the invention.

The fluorine-containing elastomer covered electric wire 1 of the embodiment comprises a conductor 10 and a covering layer 20 formed on the periphery of the conductor 10.

### Conductor 10

The conductor 10 is formed of a material capable of transmitting electrical signals therethrough, such as a metal material with a predetermined diameter. In detail, the conductor 10 may be of a metal material such as copper and copper alloys. Alternatively, the conductor 10 may be a copper wire, a copper wire with a plated surface thereon, a copper alloy wire including copper and another metal, a wire with a multilayer structure formed by combining copper and another metal, or a material formed by sintering a metal particle of a given metal. The plating may be tin plating etc.

The conductor 10 has a diameter of, e.g., not more than 1 mm. The conductor 10 may be shaped like a single conductor about circular in cross section in FIG. 1, but may be a stranded conductor with plural conductors stranded, or shaped like a tube. When the conductor 10 is formed of a stranded conductor, it may be a stranded conductor with plural plated conductors stranded, wherein each of the plated conductors has a previously plated surface, or a stranded conductor formed by first twisting plural conductors and then plating them collectively on the surface of the twisted conductors.

### Covering Layer 20

The covering layer 20 is formed of a material that is excellent in flexibility, heat stability, electrical insulation property, heat resistance, oil resistance, chemical resistance, and/or flame retardance, and cross-linkable. For example, the covering layer 20 may include a tetrafluoroethylene-propylene system copolymer and a fatty acid amide. In detail, the covering layer 20 may comprise a composition comprised of 100 parts by weight of tetrafluoroethylene-propylene system copolymer and not less than 0.1 parts and not more than 10 parts by weight of fatty acid amides. In order to secure the heat resistance and formability, the tetrafluoroethylene-propylene system copolymer may preferably have a mole ratio of tetrafluoroethylene to propylene in the range of 90/10 to 45/55. The covering layer 20 is formed to cover the periphery of the conductor 10. The covering layer 20 preferably has a cross-linking structure.

The tetrafluoroethylene-propylene system copolymer may comprise, as a main component, tetrafluoroethylene and propylene, and a component capable of being copolymerized with the main component. The copolymerized component may be, e.g., ethylene, butene-1, isobutene, acrylic acid and alkyl esters of acrylic acid, methacrylic acid and alkyl esters of methacrylic acid, vinyl fluoride, vinylidene fluoride, hexafluoropropene, chloroethylvinylether, glycidylvinylether, chlorotrifluoroethylene, perfluoroalkylvinylether etc.

The composition may include, as another component other than the main component, a cross-linking aid, a flame retardant aid, an antioxidant, a lubricant, a stabilizing agent, a filler, a colorant, and/or silicone resin etc. The content of the other components than the main component for the tetrafluoroethylene-propylene system copolymer may desirably not more than 30% with respect to the main component.

### Method for Making the Fluorine-Containing Elastomer Covered Electric Wire 1

FIG. 2 is a process diagram showing a method for making the fluorine-containing elastomer covered electric wire in the embodiment of the invention.

At first, the conductor 10 is provided (hereinafter referred to as “conductor providing step” or “step S10”). Then, a compound (i.e., composition) formed by kneading the predetermined amount of tetrafluoroethylene-propylene system copolymer and the predetermined amount of fatty acid amide is extruded on the periphery of the conductor 10 to form the covering layer 20 (hereinafter referred to as “covering layer forming step” or “step S20”). Then, the covering layer 20 is cross-linked (hereinafter referred to as “cross-linking step” or “step S30”). The cross-linking step may include a cross-linking treatment step by a cross-linking agent (e.g., organic peroxide) being previously included in the composition, or a cross-linking treatment step for irradiating the composition with electron beam or ultraviolet rays. Thereby, the fluorine-containing elastomer covered electric wire 1 of the embodiment can be obtained.

### Effects of the Embodiment

According to the embodiment of the invention, the fluorine-containing elastomer covered electric wire 1 can have the covering layer 20 that is enhanced in stripping property and formed by extruding on the periphery of the conductor 10 the compound formed by kneading the predetermined amount of tetrafluoroethylene-propylene system copolymer and the predetermined amount of fatty acid amide. Therefore, the fluorine-containing elastomer covered electric wire 1 with the excellent terminal processing property can be provided. In other words, the fluorine-containing elastomer covered electric wire 1 can be excellent in wire stripping property, so that the conductor 10 can be prevented from being damaged in stripping the covering layer 20 from the conductor 10.

The composition composing the covering layer 20 may apply to rubber packing (or gasket) and a sealing member that need the heat resistance, other than the fluorine-containing elastomer covered electric wire 1 of the embodiment.

### Examples

Fluorine-containing elastomer covered electric wires in Examples 1 to 5 are produced that the covering layer 20 formed of the composition as shown in Table 1 is formed on the periphery of the conductor 10. Also, fluorine-containing elastomer covered electric wires in Comparative Examples 1 to 3 are produced that the covering layer formed of the composition as shown in Table 1 is formed on the periphery of the conductor.

TABLE 1

| | | | Example (wire) | | | | | Comparative Example | | |
|---|---|---|---|---|---|---|---|---|---|---|
| | | | (parts by weight) | | | | | (wire) (parts by weight) | | |
| Samples | | | 1 | 2 | 3 | 4 | 5 | 1 | 2 | 3 |
| Components | tetrafluoroethylene-propylene system | | 100 | 100 | 100 | — | — | 100 | 100 | — |
| | copolymer (*1) | | | | | | | | | |
| | tetrafluoroethylene-propylene system | | — | — | — | 100 | — | — | — | 100 |
| | copolymer (*2) | | | | | | | | | |
| | tetrafluoroethylene-propylene system | | — | — | — | — | 100 | — | — | — |
| | copolymer (*3) | | | | | | | | | |
| | cross-linking agent (dicumyl | | 3 | 3 | 3 | 3 | 3 | 3 | 3 | 3 |
| | peroxide) | | | | | | | | | |
| | cross-linking aid (triaryl isocyanurate) | | 5 | 5 | 5 | 5 | 5 | 5 | 5 | 5 |
| | filler (*4) | | 10 | 10 | 20 | — | — | 10 | 10 | 10 |
| | filler (calcium carbonate, *5) | | — | — | — | 30 | 10 | — | — | — |
| | fatty acid amide (*6) | | 0.1 | 3 | — | — | — | — | 11 | — |
| | fatty acid amide (*7) | | — | — | 10 | 1 | 3 | — | — | — |
| | fatty acid (stearic acid) | | — | — | — | — | — | — | — | 3 |
| Plating of conductor | | | no | no | no | tin | tin | no | tin | tin |
| Evaluation | Tensile strength (MPa): target 12≦ | | 17.8 | 16.5 | 13.2 | 14.1 | 15.1 | 18.2 | 11.6 | 16.2 |
| results | Elongation (%): target 350≦ | | 520 | 580 | 660 | 480 | 500 | 500 | 690 | 540 |
| | Terminal processing property (wire | | ◯ | ◯ | ◯ | ◯ | ◯ | X | ◯ | X |
| | stripping property) | | | | | | | | | |
| | Thermal | tensile strength | 102 | 92 | 85 | 100 | 96 | 100 | 76 | 90 |
| | aging | remaining rate (%): | | | | | | | | |
| | resistance | target 80%≦ | | | | | | | | |
| | | elongation remaining | 100 | 94 | 85 | 85 | 89 | 100 | 74 | 92 |
| | | rate (%): target 80%≦ | | | | | | | | |

(*1), (*2) and (*3): Aflas(TM) 150E, 150C and 150CS, respectively, from Asahi Glass Co., Ltd.,
(*4): Aerosil (TM) R972 from Toshin Chemicals Co., Ltd.,
(*5): VIGOT-10 from Siraishi Calcium Kaisha, Ltd.,
(*6) and (*7): Diamide O-200 and Slipacks O, respectively, from Nippon Kasei Chemical Co., Ltd.

In Example 1, the components as shown in Table 1 are weighed and then kneaded in a roller (or kneader) heated at 50 to 60° C. for 15 min. Thereby, the compound of Example 1 is formed. Then, the compound is injected into a 40 mm extruder (which is L/D=24) that the temperature of a head, a first cylinder and a second cylinder is set to be 120° C., 80° C. and 120° C., respectively. Then, the compound is extruded on the periphery of a copper stranded conductor (which is 0.78 mm in conductor diameter, and seven in the number of stranded conductors) such that the covering layer is 0.55 mm in thickness. Simultaneously, the compound is cross-linked by exposing the covering layer into steam at 12 atm. Thus, the fluorine-containing elastomer covered electric wire in Example 1 was produced. In like manner, the electric wires in Examples 2 to 5 as well as Comparative Examples 1 to 3 are produced.

Then, the fluorine-containing elastomer covered electric wires in Examples 1 to 5 as well as Comparative Examples 1 to 3 are evaluated in relation to the mechanical property, terminal processing property, and heat resistance (or thermal aging resistance). The evaluation of the properties is conducted as below.

### Tensile Properties

The covering layer after pulling the conductor from the fluorine-containing elastomer covered electric wire is subjected to the tensile test conforming to the guideline, RS-K-6301, whereby tensile strength (MPa) and elongation (%) are measured. As measured in the tensile test, the value of the tensile strength and elongation for the fluorine-containing elastomer covered electric wires in Examples 1 to 5 and Comparative Examples 1 to 3 is determined as an initial value.

### Terminal Processing Property (Wire Stripping Property)

The stripping test of the covering layer is conducted by using a commercially available stripper so as to cut a part 25 mm away from the terminal end of the fluorine-containing elastomer covered electric wires in Examples 1 to 5 and Comparative Examples 1 to 3. The test is repeated for 20 samples of each of the fluorine-containing elastomer covered electric wires in Examples 1 to 5 and Comparative Examples 1 to 3. When at least one of the 20 fluorine-containing elastomer covered electric wires in any Example causes a disconnection in the conductor, the Example is evaluated as not acceptable (X). When none of the 20 fluorine-containing elastomer covered electric wires in any Example causes the disconnection in the conductor, the Example is evaluated as acceptable (O).

### Thermal Aging Resistance (or Heat Resistance)

The covering layer after pulling the conductor from the fluorine-containing elastomer covered electric wire is retained in a Geer type oven (which is set at 232° C.) at an air exchange rate of 200 chamber volume/hr for seven days and then subjected to the tensile test conforming to the guideline, JIS-K-6301, whereby tensile strength (MPa) and elongation (%) are measured. From the measured values, the remaining rate (%) of the tensile strength and the remaining rate (%) of the elongation to the initial value is calculated.

The results of the above tests for the fluorine-containing elastomer covered electric wires in Examples 1 to 5 and Comparative Examples 1 to 3 are exhibited in Table 1.

As seen from Table 1, the fluorine-containing elastomer covered electric wires in Examples 1 to 5 are all 13.2 or more in the tensile strength, 480 or more in the elongation, “acceptable” in the wire stripping property, 85 or more in the remaining rate of tensile strength and the remaining rate of elongation. Thus, they are excellent in all of the mechanical property, the terminal processing property and the heat resistance.

By contrast, the fluorine-containing elastomer covered electric wire in Comparative Example 1 is evaluated “not acceptable” in the wire stripping property, since no fatty acid amide is added. Although the fluorine-containing elastomer covered electric wire in Comparative Example 2 is evaluated “acceptable” in the wire stripping property, the thermal aging resistance lowers since the fatty acid amide is added at more than the predetermined amount. The fluorine-containing elastomer covered electric wire in Comparative Example 3 is evaluated “not acceptable” in the wire stripping property, since the other fatty acid than the fatty acid amide such as stearic acid is added and causes a disconnection in the conductor.

Although the invention has been described with respect to the specific embodiments and Examples for complete and clear disclosure, the appended claims are not to be thus limited. In particular, it should be noted that all of the combinations of features as described in the embodiment and Examples are not always needed to solve the problem of the invention.

What is claimed is:

1. A fluorine-containing elastomer covered electric wire, comprising:
a conductor; and
a covering layer on a periphery of the conductor,
wherein the covering layer comprises a composition comprising 100 parts by weight of a tetrafluoroethylene-propylene system copolymer and 0.1 to 10 parts by weight of a fatty acid amide.

2. The fluorine-containing elastomer covered electric wire according to claim 1, wherein the covering layer comprises a cross-linking structure.

3. The fluorine-containing elastomer covered electric wire according to claim 2, wherein the tetrafluoroethylene-propylene system copolymer comprises a mole ratio of tetrafluoroethylene to propylene in a range of 90/10 to 45/55.

4. A method for making a fluorine-containing elastomer covered electric wire, comprising:
forming on a periphery of a conductor a covering layer comprising a composition comprising 100 parts by weight of a tetrafluoroethylene-propylene system copolymer and 0.1 to 10 parts by weight of a fatty acid amide,
cross-linking the composition so as to form a cross-linking structure in the covering layer.

5. The method according to claim 4, wherein the cross-linking of the composition comprises a cross-linking by a cross-linking agent previously included in the composition, or a cross-linking by irradiating the composition with electron beam or ultraviolet rays.
